(19) United States
(12) Patent Application Publication
(10) Pub. No.: US 2014/0268314 A1
(43) Pub. Date: Sep. 18, 2014

(54) Three-beam Coherent Beam Combining System

(71) Applicant: Robert H. Dueck, Santa Ana, CA (US)

(72) Inventor: Robert H. Dueck, Santa Ana, CA (US)

(21) Appl. No.: 14/216,425

(22) Filed: Mar. 17, 2014

Related U.S. Application Data
(60) Provisional application No. 61/799,010, filed on Mar. 15, 2013.

(51) Int. Cl. G02B 27/10; H01S 3/00

(52) U.S. Cl. CPC G02B 27/1086; H01S 3/005
USPC 359/349; 359/566

(57) ABSTRACT

Apparatus 110 and methods for the coherent beam combining of three beams 101, 102, 103 from laser sources. In one embodiment, a two-beam coherent combiner 27 comprises two laser sources 1, 2, a repeated pattern optical element 22 that functions as a two port diffractive beam combining element, and a method for adjusting the relative phase difference between the two beams to improve the combined beam 23 output. In another embodiment, a three-beam coherent beam combiner 110 comprises three laser sources 101, 102, 103, a repeated pattern optical element 111 that functions as a three port diffractive beam combining element, and a method for adjusting the relative phase difference between the three beams to improve the combined beam 123 output. The apparatus 27, 110 and methods disclosed can be used in external cavity laser configurations 200, 300 to combine two or three laser resonator gain paths into phased paths for improved single wavelength combined beam performance.

### CROSS-REFERENCE TO RELATED APPLICATIONS

The present application claims the priority of U.S. Patent Application Ser. No. 61/799,010 filed Mar. 15, 2013, which application is incorporated in its entirety herein by reference.

### BACKGROUND OF THE INVENTION

The present inventions relate generally to the field of lasers and in particular to methods and apparatus for combining three or less beams into a composite beam having higher laser power.

Laser systems that use multiple laser sources or multiple laser gain medium, are utilized in a variety of applications including cutting, machining, welding, material processing, laser pumping, fiber optic communications, free-space communications, illumination, imaging and numerous medical procedures. Many of these applications can be significantly benefited with higher laser power. In support of achieving higher laser power, the input energy is typically increased. However, simply increasing the input energy may introduce additional thermal management considerations. For example, thermal conditions and heat load within the laser gain medium typically contribute to internal aberrations and corresponding beam quality reductions in the emitted radiation. Additionally, unaddressed internal heating may also lead to internal damage of the laser components themselves. In general, issues like these place practical limits on the achievable laser power for a given laser system design approach. In many cases the most cost effective method for further power scaling is achieved by combining the optical outputs from more than one laser or laser gain medium.

The ability to focus a laser beam into a small spot is generally characterized by its beam quality which is in part, a measure of its usefulness in a many applications. Ideally, laser power scaling through beam combining of multiple laser sources or multiple laser gain medium would be done in a manner that minimizes the reduction in the beam quality of the combined beam. When considered in combination, both laser power and laser beam quality contribute to what is typically termed beam brightness. When either or both laser beam power and laser beam quality are improved, the brightness of the laser beam is said to be improved. Beam brightness, being a measure of the combination of the power and focusability of a laser beam, is a fundamental measure of a laser beam's overall utility in many high power applications.

Historically, many methods have been used to advance the above objectives with varying degrees of success. These methods can be organized into three broad categories of design approaches, namely coherent, incoherent and polarization approaches. They can be used in isolation of each other or in combination to further improve performance. Methods characterized by polarization approaches are simple to implement but, by themselves, do not scale beyond a factor of two, one for each available polarization. Incoherent approaches are relatively easy to implement and can provide for significant power scaling beyond two beams but, because of the wide range and number of wavelengths typically employed, may not be suitable in applications requiring a narrow wavelength range. Coherent approaches also have the ability to power scale significantly a large number of beams and, by their very nature, can do so over a very narrow range of wavelengths. As a consequence, coherent approaches require very specific phase relationships between the given beams. These phase relationships are critical for achieving optimal beam combining. Even in ideal circumstances, a beam combining system my need non-zero phase differences between the various beams in order to optimally combine. Furthermore, these systems may additionally require real time beam phasing between the laser sources or laser gain medium to compensate for phase stability errors typically observed in real world systems. Depending on the magnitude and the rates of change of these errors, phase compensation techniques can be complex and costly to implement. Nevertheless, in some systems it may be possible to construct them with a high degree of stability and symmetry, requiring only small slowly changing phase compensating corrections between the laser beams or laser gain medium paths. Furthermore, in some coherent beam combining systems the initial phasing requirements may not be known ahead of time, but may also have a high degree of stability such that it may be possible to initially introduce and set the phasing as a part of a calibration and alignment step and not require continuous readjustment of the phasing.

An example of a method of phase compensation is through the use of an electrically modulated crystals such as a Pockels cell. In this type of system, the light is directed through a birefringent crystal, such as lithium niobate, which itself is placed in an electric field. As the strength of the electric field is changed, the index of refection of the crystal in a given polarization axis is changed, thus briefly slowing down or speeding up, the beam as it passes through it. This effectively changes the piston phase of the standing wave of the laser beam passing through it. Furthermore, because Pockels cells can react quickly this method can be used in systems requiring very high rates of change. Another method of phase compensation is to direct the beam through one or more plane-parallel glass plates that can be tilted. As the plates are tilted, the light path is slightly deviated and passes through more glass than air, effectively increasing the path length and introducing a piston phase change. This method, although simple to implement, is ideally used in systems requiring only slowly changing corrections. Another method of phasing compensation typically used in diode lasers is to change the driver current to individual diodes. This method slightly changes the power output of an individual laser beam, but only by inconsequential amounts while significantly changing the piston phase. Still other methods might apply heat to an optical element to make it expand, or move a mirror to increase a path length, but in each case, something is done differently to one laser beam path or laser gain medium path, with respect to the other paths.

In a distinctly separate but related topic for coherent beam combining approaches, the method of measuring (as distinct from the method of introducing) the piston phase difference between laser beams, is also a challenging matter. This measurement can be difficult to implement, especially at high rates. In general, these measurements involve an indirect measurement of the phase by virtue of a measurement of the intensity of a combined beam or sample of the a combined beam, where the measured intensity can be related to the relative piston phase difference between the two beams.

Prior art coherent beam combining approaches, such as those described in U.S. Pat. No. 8,340,150 B2 filed on May 23, 2011, describe several embodiments of apparatus that can, in concept, be used to coherently combine two or more beams. It is presented here as an example of historically incomplete descriptions and understandings of the coherent combining processes and its requirements. In this example there is a description of how proper phasing between beam paths can be achieved. The author properly recognizes that proper phase relationships must be achieved for beam combining to occur, but the discussion suggests at column 3 line 20 that “. . . the proper phase condition for the reconstruction of the output beam is likely to occur spontaneously . . . due to the dense mode spacing . . . ” and also at column 5 line 54 the description states that “Together with the BCE (the Beam Combining Element shown as 150 in their FIGS. 1a and 1b), the path selector (shown as 180 in these same figures) may force a particular phase state for the ensemble of phase-locked emitters that would produce constructive interference from all the emitters in the output of the system.” Both of these statements could, in concept, be correct if it were not for the fact that a beam combining element (such as diffractive optical element or DOE) will itself introduce (or require) significant phase differences between the different beams as part of its splitting (or combining) process. In order for the coherent beam combining systems described there to constructively interfere into a single beam, the phase relationships of the beam combiner itself (which are not necessarily zero) must be properly accounted for. In other words, if the same laser line (i.e same laser wavelength) is to be used within all beams and beam paths (assuming that there is more than two), then a phasing solution is not likely to be naturally or “spontaneously” found for one wavelength by even a perfectly constructed system, even in the presence of a “path selector” as suggested. Unless more than one laser line (or equivalently more than one laser wavelength) is considered, phasing, or phase differences, must be introduced into the individual beam paths by the proper introduction of added phase within each path and must account for, and match, all the path lengths (modulo 2π radians or one wavelength) including the phase differences between the different paths inherently introduced by the BCE (Beam Combining Element) before a single laser line can spontaneously be selected by the system and operate in all beam paths. In this respect, the prior art is deficient.

### BRIEF SUMMARY OF THE INVENTION

The present invention addresses the above and other needs by providing methods and apparatus for coherent-light beam combining of two or three laser sources, or two or three laser gain medium optical paths in an external cavity laser resonator configuration. In addition, the invention discloses methods whereby arbitrary phase differences of at least one wave can be introduced between the beams or beam paths of a coherent beam combining apparatus.

A common component in the embodiments of this invention is abeam combining element. A single optical element is used as the coherent beam combiner and can be used to combine two or three beams into one beam. This element can be a one-dimensional; diffractive optical element (DOE), holographic element, Dammann grating (DG), volume Bragg grating (VBG), or one of many other types of repetitive pattern optical elements that makes use of repetitive pattern optical interference effects. This element can be transmissive or reflective.

The individual laser beams, or laser gain medium beam paths, are first directed to overlap and cross paths at a common location. The beams are arranged so that the vectors representing the propagation directions are in a single plane and approach the beam combining element from different angles. Each angle represents a different diffraction order, and therefore a different diffraction angle, of the repetitive pattern on the beam combining element.

At or near the beam overlap location the beam combining element may be placed. It may combine all of the beams simultaneously into a common beam emerging from the combing element and propagating in a single direction. As stated above, in order for a beam combining element, based on diffractive interference effects, to coherently combine beams effectively, very specific phase relationships must be established and maintained between the beams at the location of the beam combining element. If these phase relationships are not present, the beam combining process will not be efficient and light may diffract into various undesired directions associated with the various diffraction orders of the combining element. Again as stated above, different types of beam combining elements may have different requirements for these phase relationships. For example, in one type of three beam Dammann grating having equal and high diffraction efficiency of nearly 28.8% in each of three diffraction orders, the phase relationship requirements are such that the three beams are not all in phase simultaneously at the combiner. In a nominal theoretically perfectly built system using this beam combiner element, the two other beams must be in phase with a zero phase difference, and the center beam must be out of phase with respect to the two other beams by a quarter of a wave, namely π/2 radians. To the degree that these phase relationships are not matched, the combining efficiency will be reduced. In another system that might make use of a beam combiner element made from an improved Fourier based calculation for the diffraction grating where the efficiency is increased to 31% in each of three orders (or nearly the limit of perfection of 33.3%), the phase relationships required for optimal combining between these three beams, may be yet another set of phase differences distinctly different from those of the Dammann grating discussed above. For this reason, the present invention discloses a relative beam phasing method whereby, two degrees of adjustment freedom may be used to change the phase differences between three laser beams, or laser gain medium paths, at the critical location of the beam combiner. In addition, as a subset to the three beam phasing method, a one degree of adjustment freedom method is also disclosed that may be used to change to phase difference between two laser beams, or laser gain medium paths.

In order to introduce these arbitrary phase differences between three beams, this invention discloses that phase differences may be introduced into the beam paths by two disclosed physical translations of the beam combining element itself. It is disclosed herein that translations of the combining element in a first direction that is both perpendicular to the center beam and in the direction of the repetitive pattern on the beam combiner, will change the phase difference between the two outer beams of the beam combiner. The phase difference between the average phase of the two outer beams and the center beam generally do not change with beam combiner motions in this first direction of translation. Nevertheless, it is also disclosed herein that a translation of the beam combiner element in a second direction that is parallel to the direction of propagation of the center beam, what is generally considered the optical axis, will change the phase relationship between the center beam and the two other beams. Between these two directions of translations, all three beams can be phased arbitrarily.

Translations of the beam combiner element in the first direction of the motion do not change the amount of overlap of the three beams at the beam combining element, whereas translations of the beam combiner element in the second direction of motion will cause the three beams to become slightly non-overlapped at the beam combiner element. The fact that the beams are not perfectly overlapped will degrade beam combining performance. This reduction in performance comes from an edge effect whereby a loss of three-beam interference occurs at the edges of the beams. Nevertheless, this edge effect, and the reduction in performance caused by it, is extremely small for typical beams and for beams propagating at typical angles of incidence. Only in systems with beams having very small diameters and propagating at incident angles that are nearly identical, does the edge effect become significant before at least one wave of phase difference can be introduced between the beams. In general, these two disclosed motions of the beam combiner element provide two degrees of freedom to arbitrarily phase three laser beams, or laser gain medium paths, in order to achieve high combining efficiency in a combined beam.

In accordance with one aspect of the invention, the two (or three) laser sources can be two (or three) individual diode laser emitters having a common wavelength. In another aspect of the invention, the two (or three) laser sources can be derived from a single laser source that is itself emitting two (or three) standing wave beams having a common wavelength.

In accordance with another aspect of the invention, beam delivery optics can be used to direct the individual beams to a common overlap region. These beam delivery optics can be lenses, mirrors, prisms, or any other beam deflection, refraction or diffractive element that may modify and/or direct a beam or set of beams to a common overlap region. Furthermore, these beam delivery optics may be used to modify and/or direct all beam at once or may be used to with individual beams.

In accordance with another embodiment of the invention, an external laser cavity arrangement can be constructed. In this embodiment, individual laser gain emitter paths are arranged to direct light paths, starting from emitters (having gain and a high reflectivity back surface mirrors), traversing through a common overlap region where the beam combining element is placed, and ending at a partially reflecting output coupler placed after the beam combiner element. The output coupler is arranged to redirect a portion of the combined beam back to the emitters, and transmits another portion of the combined light, allowing the formation of a multi-path external laser resonator cavity arrangement. Then, when the method of two or three beam phasing, disclosed in this invention, is employed in such an external cavity arrangement, the phase relationships between the two or three paths can be adjusted to create the proper phase differences that will allow for high efficiency lasing, in a combined beam path resonator apparatus.

In an example of an external laser resonator embodiment, the output coupler may be a partially reflecting broad wavelength band mirror. In still another embodiment, the output coupler may be the beam combining element having a partially reflecting coating placed on its surface. Still other embodiments of the output coupler are volume Bragg gratings that may reflect a selectively narrow wavelength band, a diffraction grating that may have a blazed surface that may create a diffraction efficiency such that it directs some of the light into the zero-order return-beam direction, or a phase conjugate mirror that redirects a portion of the light back on itself. In these examples of an output coupler, a single element or a set of elements can be used to select a wavelength, range of wavelengths, or set of individual wavelengths, and have a portion of the energy at those wavelengths be redirected toward the opposite end, or ends, of the laser resonator cavity through the beam combiner element.

In another embodiment of a method of coherent beam combining in an external resonator embodiment, one or more output couplers can be placed before the beam combining element. In this type of embodiment, the output coupler or couplers create individual resonator cavities paths that do not include the beam combining element. In this case, each resonator cavity will lase on it own. If the cavity lengths and the indices of refraction for the optics within each path are similar, the outputs of each cavity will be sets of wavelength lines that are nearly identical. Nevertheless, since they can not be made exactly identical, they will generally emerge from the output coupler, or couplers, as sets of standing waves with arbitrary and unknown piston phase relationships between them. When the beams emerging from these external resonator cavities are directed toward a beam combiner according to aspects of this invention, and when the phase differences are optimized by translations of the beam combiner according to aspects of this invention, a single combined beam may emerge from the beam combiner element, whereby many, if not all, of the laser wavelength lines, within the gain bandwidth of the lasers, are emerging from the beam combiner in phase.

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE SEVERAL VIEWS OF THE DRAWING

Various aspects of at least one embodiment are discussed below with reference to the accompanying figures, which are not intended to be drawn to scale. Where technical features in the figures, detailed description or any claim are followed by references signs, the reference signs have been included for the sole purpose of increasing the intelligibility of the figures, detailed description, and claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. The figures are provided for the purposes of illustration and explanation and are not intended as a definition of the limits of the invention. In the figures:

FIG. 1 is a schematic diagram of two laser beams overlapping, according to aspects of the present invention;

FIG. 2 is a schematic diagram of another view of two-beam overlap, according to aspects of the present invention;

FIG. 3 is a schematic diagram of two-beams overlapping and illustrating a two-beam interference phase shift, according to aspects of the invention;

FIG. 4 is a illustration of a repeated pattern optical element, according to aspects of the invention;

FIG. 5 is an illustrative schematic representation of a three-beam overlap arrangement, according to aspects of the invention;

FIG. 6 is a schematic diagram of two-beam coherent beam combining arrangement, according to aspects of the invention;

FIG. 7 is a schematic diagram of a two-beam combiner illustrating two-beam phase compensation, according to aspects of the invention;

FIG. 8 is a schematic diagram of a three-beam combiner illustrating three-beam phase compensation, according to aspects of the invention;

FIG. 9 is a schematic diagram of one example embodiment of an external laser cavity three-beam combiner illustrating three-beam phase compensation, according to aspects of the invention;

FIG. 10 is a schematic diagram of another example embodiment of an external laser cavity three-beam combiner illustrating three-beam phase compensation, according to aspects of the invention;

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments. Furthermore, although the following discussion may refer primarily to lasers as an example, the aspects and embodiments discussed herein are applicable to any type of electro magnetic source that has a nominally single characteristic wavelength, including, but not limited to, semiconductor lasers, diode lasers and fiber lasers, laser amplifier, and master oscillator power amplifier systems.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, first dimension and second dimension, and vertical and horizontal are intended for convenience of description, not to limit the present systems and methods or their components to any one positional or spatial orientation.

The present invention is directed toward beam combining implementations and beam phasing methods, for coherently combining the laser beams from two or three laser sources into a single coherent beam to enhance power and brightness.

The present discussion is directed toward FIG. 1. Shown there is an illustration of two laser beams 10 overlapping and creating two-beam constructive and destructive interference. A first beam 1 and a second beam 2 have the same wavelength λ, are nominally collimated, and are directed in a first beam direction 3 and second direction 4 toward an overlap region 8. The two beams 1 and 2 travel with an angle between the two beams 6 of 2θ. A center line 7 bisects the angle between the two beams 6 and makes an angle 5θ with respect to either beam 1 2. If the first beam 1 and second beam 2 are both formed by lasers having standing wave propagations (which is generally the case for lasers), then the two beams will interfere constructively and destructively in the overlap region 8 according to the details of their phase relationship. A depiction of a two-beam intensity interference 9 pattern in and round the overlap region 8 is shown as the two-beam intensity interference 9 sine wave shown in FIG. 1. When two beams are interfered in this manner, they create a repetitive intensity pattern that has a character period of τ=λ/sin(2θ).

Moving on to FIG. 2, the two-beams overlapping 10 depiction is shown slightly modified by cutting off the first beam 1 and second beam 2 near the overlap region 8. A first beam leading wavefront edge 11 and a second beam leading wavefront edge 12 are shown “in-phase” at the overlap region 8. The “in-phase” attribute of the two-beam interference 9 pattern is illustrated by placing a peak intensity lobe at the center line 7, a point where the first beam leading wavefront edge 11 and the second beam leading edge wavefront edge 12 intersect, and therefore represent a location of constructive interference.

Continuing to FIG. 3, the two beams overlapping 10, shown in the previous two figures, are illustrated here in an example of beams overlapping with a half-wave of piston phase shift 17. In this depiction, a half-wave of piston phase change 14Λ (typically quantified in units of length but can also be quantified in units of waves at some assumed wavelength, or radians also at some assumed wavelength) has been introduced into the second beam 2 in a direction of the piston phase change 15 shown. The effect of the piston phase change 14 on the two-beam intensity interference 9 pattern is to move the two-beam intensity interference 9 pattern in the overlap region 8 and in the direction of interference fringe shift 16 by an amount δ=(Λ/λ)τ. An optical element placed in the overlap region 8 that follows the motion of the interference fringe shift 16, can not be affected by the fringe shift 16 and therefore also can not be affected by the piston phase change 14 that created the fringe shift 16.

An illustration of one example of a repeated pattern optical element 21 is shown in FIG. 4. A typical repeated pattern 18 is shown as having a repeated pattern period 19 and in a repeated pattern direction 20. An example of a repeated pattern optical element 21 often used in beam splitter systems to divide a single beam into multiple beams, is the Dammann grating, sometime also referred to as a diffractive optical element (DOE). In one example of a Dammann grating used as a two port beam splitter, is one in which the repeated pattern 18 has facet heights that introduce a ½ wave of phase shift with a 50% duty cycle over the small regions within the repeated pattern 18. This results in a two port device whereby the +1 and −1 orders of the diffracted light have high efficiency and where all other orders, including the center zero order, are suppressed. If the facet heights are changed and set to a value that creates 0.32 waves of phase shift with the same 50% duty cycle, the Dammann grating becomes a 3 port device whereby the efficiency of the center zero order undiffracted light is made to be equal to that of the +1 and −1 diffracted orders. In this way, gratings having the same repeated pattern period 19, can be either a two port or three port devices. Additionally, by making use of blazed angles in diffraction gratings or Bragg angles in volume gratings, a two port device can be constructed that makes use of only one first order diffracted beam and the zero order undiffracted beam. When these repeated pattern optical elements are not used as beam splitters, but are used in reverse, they may reverse the effects of diffractive beam splitting and can become diffractive beam combiners. To do so efficiently, many exacting phasing conditions must be met.

One of the conditions for efficient beam combing with a repeated pattern optical element 21 used in reverse is period matching of the repeated pattern 18 with that of the period of the two-beam intensity interference 9 pattern. In the example of a two-port Dammann grating device having high efficiency in only the two first orders, the repeated pattern period 19 for this device should be equal to 2(λ/sin(2θ)). In an example of a three-port Dammann grating device having high efficiency in both of the first diffracted orders as well as the center undiffracted order, the repeated pattern period 19 for this device should be equal to (λ/sin(θ)) if it is to be used to coherently combine three beams, each angularly separated by θ. In examples of two-port devices using only one first order diffracted beam and the center zero order undiffracted beam, the repeated pattern period 19 should be (λ/sin(2θ)).

Shown in FIG. 5 is an illustration of a three-beam arrangement 100 whereby a first beam 101 and a second beam 102 and a third beam 103 are directed in a set of beam propagation directions 104 toward a three beam overlap region 108. Each beam has a wavelength λ. The outer angle 106 formed between the propagation direction of the first beam and the propagation direction of the third beam is 2θ, and is twice that of an inner angle 105 denoted by θ which is formed by either the first beam 101 or the second beam 102, with respect to the normal to the overlap region 108. Additionally, the propagation direction of the third beam 103 is normal to the over the overlap region and parallel to the center line 107. Analogues to the two-beam intensity interference 9 pattern discussed above, a three-beam intensity interference 109 pattern is created in the three beam overlap region 108. The detailed structure of this intensity pattern is more complicated than that of the simple sine wave for the two-beam intensity interference pattern 9, but the period of the three-beam intensity interference 109 pattern is still characterized by the smallest angle between any two beams and is therefore given by λ/sin(θ).

In FIG. 6 is shown an example of a two-beam coherent combiner 25 embodiment according to aspects of the this invention. Shown there is a repeated pattern optical element 22 that is placed at or near the two-beam overlap region 9 as shown. The repeated pattern optical element 22 is constructed with a repeated pattern period 19 (shown in FIG. 4) that appropriately matches the angle between the two beams 6 and the period for the repeated two-beam intensity interference 9 pattern as discussed above. At the interface of the two-beam intensity interference 9 pattern and the repeated pattern optical element 22, a diffractive interaction occurs that may combine the first beam 1 and the second beam 2 into a combined beam 23 beam propagating in the combined beam direction 24 and having higher power and brightness.

According to aspects of this invention, an example of a method of two-beam phasing is illustrated and disclosed in FIG. 7. In this figure, a two-beam combiner with piston error compensation 27 is shown. In like manner to that shown in FIG. 3 above, a piston phase change 14 in the direction of piston phase change 15 is illustrated. The piston phase change 14 causes a translation of the two-beam intensity interference 9 fringes. This translation is in the direction of interference fringe shift 16. Two-beam piston phase compensation can be achieved by the disclosed method of translating the repeated pattern optical element 22 in a manner that follows the magnitude and the direction of the interference fringe shift 16 with a two-beam phase compensating motion 26 as illustrated. The magnitude of the required shift is proportional to the piston phase change 14Λ and is given by Δ=(Λ/λ)τ where τ is the period of the two-beam intensity interference 9, namely τ=λ/sin(2θ). Therefore, a translation motion 26 equal to τ represents a full wave, namely Λ=λ, of piston phase shift 14. When the piston phase compensation required is not known, the power output in the combined beam 23 can be monitored and optimized with dither motions of the repeated pattern optical element 22 over a dither range of at least τ. At the position of the repeated pattern optical element 22 whereby the power output in the combined beam 23 is maximized, the repeated pattern optical element 23 will be introducing the best piston phase compensation between the two beams. This optimized location will create the best phasing conditions in the overlap region 8 and may optimally take into account the piston phase difference errors and requirements throughout the apparatus.

In FIG. 8 is illustrated an embodiment of a three-beam coherent beam combiner 110 arrangement according to aspects of this invention. The three individual beams that are to be combined are shown as first beam 101 and second beam 102 and third beam 103. In this example a three-beam repeated pattern optical element 111 with high efficiency in the +1 and −1 and zero order beams, and with a repeated pattern period of λ/sin(θ), may be placed in the three-beam overlap region 108 to coherently combine the three input beams into a single combined beam 123. The single combined beam 123 may exit from the repeated pattern optical element 111 in the exit direction 124 as shown. In order for the efficiency of the three-beam combining to be high, the piston phase relationships between all three beams must be optimally set. Since there are three beams and two piston phase differences, phasing three beams requires two degrees of phasing freedom. An example of the method disclosed in this invention for adding a second degree of phasing freedom is by translating the repeated pattern optical element 111 along a path away from the plane of the overlap region 108 and not in the plane of the overlap region 108. For example, the repeated pattern optical element 111 may be translated along an axis parallel to center line 107 as a method of second dimension phasing. In other examples, the repeated pattern optical element 111 may be translated along an axis parallel to the propagation path of the first beam 101 or the second beam 102. To further illustrate, when the repeated pattern optical element 111 is translated to a second position 112 (shown as a dashed outline of the repeated pattern optical element 111) the paths traveled by the first beam 101 and the second beam 102 are changed by a different amount than that of the third beam 103. Therein lies the source of the path difference effect introduced by this type of translation of the repeated pattern optical element 111. An estimate for the phase difference (PD) created by the path length difference introduced between the first beam 101 and the third beam 103 by a translation 113 of the repeated pattern optical element in a direction parallel to the center line 107 (or equivalently the third beam 103) in the amount x, is given by PD=x(1/cos(θ)−1). By symmetry, the same result for the phase difference created by the path length difference introduced between the second beam 102 and the third beam 103 is obtained for the same translation 113 of the repeated pattern optical element 111.

Thus, described above are examples of two different disclosed methods for compensating piston phase differences between laser beams or laser beam paths. It is noted that these two phasing methods are introduced into the beam paths with two nominally orthogonal physical translations of the repeated pattern optical element 111. Therefore, these two types of translations may be introduced simultaneously and in arbitrary amounts. It is further noted that each method, by itself, is effectively a type of two-beam phasing method, since neither method can introduce arbitrary phase difference changes between all three beams, or all three beam paths, in a three-beam coherent beam combining system 110. But when both methods are employed together whereby the repeated pattern optical element 111 may be translated in two directions 114, a new method for phasing three beams is achieved. The new method is a full three-beam phasing method whereby two arbitrary phase differences may be introduced between the three laser beams, or three laser beam paths. More specifically, by using translations of the repeated pattern optical element 111 in a direction 113 that is nominally parallel to the optical axis center line 107; and also using translations in a direction of two-beam intensity interference fringe shift 16 (as shown in FIG. 3), two degrees of piston phasing freedom may be obtained through this combined pair of motions 114 that can introduce and accommodate any set of piston phase difference requirements between all three beams, to improve beam combining efficiency in a three-beam coherent beam combiner.

The piston phasing introduced by translations in the direction of the optical axis 113 do not come without some cost to coherent beam combining efficiency. This loss in combining efficiency is derived from the fact that translations in directions away from the overlap region of all three beams 108 will cause the three beams to not be fully overlapped and not interfere at their edges. The lack of three-beam optical interference at their edges contributes to the loss in combining efficiency, even though the overall combining efficiency for the center of the beams may be improved. A worst case beam displacement 115 occurs between the first beam 101 and the second beam 102. The beam displacement 115 is proportional to the distance (X) between the repeated pattern optical element 111 and the overlap region 108. The worst case beam displacement 115 is given by disp=(2X)tan(θ). To estimate the beam combining efficiency factor loss caused by the worst case beam displacement 115, an two beam optical overlap integral can be developed and used to estimate the expected efficiency factor for a given amount of beam overlap between two beams. This results in the following beam overlap coupling coefficient equation cc=exp(−(disp/ωₒ)²) where ωₒ is the waist radius of the three beams, assuming they are all the same. As an example, if the beams are characterized by Gaussian beams with 1 mm beam waists (ωₒ) located near the three-beam overlap region 108, and if those beams were propagating toward the three-beam overlap region 108 with an angle 105θ of 5 degrees for both the first beam 101 and the second beam 102, then; to introduce one wave of piston wavefront difference between the first beam 101 and the third beam 103, a translation x₁ in the direction along the optical axis center line 113 of x₁=λ/(1/cos(θ)−1)=262 μm would be required, for light having a wavelength of λ=1 μm. This translation would induce a worst case beam displacement 115 given by disp₁=(2x₁)tan(θ) of disp₁=46 μm, for the given x₁=262 μm translation from the overlap region 108. Additionally, this one wave of added piston phasing would also result in a beam overlap coupling coefficient of cc₁=exp(−(disp₁/ωₒ)²) cc₁=0.998, for a 1−cc₁=0.2% estimated efficiency loss, an inconsequential amount of loss. Therefore, it is shown in this numerical example that this method of phasing between beams may be able to introduce at least a wave of piston phase difference between two beams, with inconsequential negative effects created by the loss of combining efficiency at the edges of the beams.

Thus, there has been described at least one embodiment and method of the two-beam coherent beam combining apparatus with method of two-beam phasing. In addition, there has been described at least one embodiment and method of the three-beam coherent beam combining apparatus with method of three-beam phasing.

Shown in FIG. 9 is an illustration of one example of an external laser cavity coherent beam combiner 200 according to aspects of the invention. In this example, a set of three laser cavity paths 205 may be configured by beam shaping and directing optics 206. These beam shaping and directing optics 206 may be; one lens, several lenses, mirrors, prisms, or any other optical element or set of elements that may aid in configuring the laser cavity paths 205 toward an overlap region 208. A high reflectivity surface 207 may be placed at one end of each laser cavity path 205 to function as a laser cavity end mirror. Each path in the set of three laser cavity paths 205 may include a laser gain medium 201 202 203. In some embodiments, the three laser gain mediums 201 202 203 may be one laser gain medium that may have three beam paths 205 that pass through it. Additionally, in some embodiments the high reflectivity surfaces 207 may be the same element. A repeated pattern optical element 210 is positioned near the overlap region 208. Additional beam shaping and directing optics 209 may be positioned between the repeated pattern optical element 210 and a partially reflecting output coupler 211. The additional beam shaping and directing optics 209 may be; one lens, several lenses, mirrors, prisms, or any other optical element or set of elements that may aid in configuring the single laser cavity path 212 between the partially reflecting output coupler 211 and the repeated pattern optical element 210. The three laser gain medium 201 202 203 are illustrated in the FIG. 9 as having different widths. This is to illustrate an example of an alternate method, not a method of this invention, by which it may be possible to introduce piston phase changes (knowing or unknowingly) into the three laser cavity paths 205. The partially reflecting output coupler 211 may be the second end mirror of the external laser cavity. The repeated pattern optical element 210 may be appropriately constructed and positioned according to the disclosures of this invention and serve as a high efficiency coherent beam combining element allowing for a high efficiency combined beam 214. For optimal lasing to occur at the same wavelength, the cavity lengths for all three laser cavity paths 205 must be appropriately set. The allowable error is typically much smaller than one wavelength of the lasing light. To appropriately set the lengths of the three laser cavity paths 205 and maximize the power in the combined beam 214 (and also in a combined beam output 215), the repeated pattern optical element 210 may be physically re-positioned in two axises of motion 218 to a new location 217 that can 1) alter and appropriately set the relative lengths of the laser cavity paths 205, and 2) also match the optical interference effects of a three-beam interference pattern 213 that will be created when lasing occurs. In this way, all three laser beams 216 can be coherently combined within the external laser cavity and allow for high efficiency lasing to occur.

Shown in FIG. 10 is an illustration of another example embodiment of an external laser cavity coherent beam combiner 300 according to aspects of the invention. In this embodiment, a set of three laser cavity paths 305 may be configured by a beam shaping and directing cylindrical lens 306 and a beam shaping and directing cylindrical fast-axis-collimator (FAC) lens 320, to shape a group of three potential laser beams 309 and direct the three cavity paths 305 to an overlap region 308. At one end of each laser cavity path 305 a high reflectivity surface 307 may be placed. Each path in the set of three laser cavity paths 305 may pass through a common laser gain medium 301 placed near the high reflector surface. A repeated pattern optical element 310 (such as a three-port diffractive optical element or a three-port Dammann grating) may be positioned near the overlap region 308. The repeated pattern optical element 310 may be appropriately constructed and positioned according to the disclosures of this invention and serve as a high efficiency coherent beam combining element allowing for a high efficiency combined beam 314. A partially reflecting output coupler 311 may be placed in the path of the combined beam 314. In this embodiment, no additional beam shaping and directing optics are placed between the repeated pattern optical element 310 and the partially reflecting output coupler 311. Also in this embodiment, the partially reflecting output coupler 311 may be a volume Bragg grating capable of selecting and reflecting a highly coherent very narrow 30 picometer wide wavelength band. The partially reflected light reflected by the output coupler 311 is directed towards the repeated pattern optical element 310. The non-reflected light transmitted by the output coupler 311 may be directed out as a coherently combined output beam 315. According to aspects of this invention, the repeated pattern optical element 310 may be re-positioned in two axises of translation 318 to a location that optimizes the coherent beam combining efficiency and the power in the combined output beam 315.

Any of the above discussed embodiments of a coherent beam combining system may be incorporated into an associated laser system. Such a laser system may include, for example, an external cavity laser system, a multi-external cavity laser system, a wavelength beam combining system, passive coherent beam combining system, polarization beam combing system, actively phased coherent beam combing system, electrical, thermal, mechanical, electro-optical and opto-mechanical laser control equipment, associated software and/or firmware, and an optical power delivery subsystem. Embodiments of the coherent beam combining laser system, and associated laser systems, can be used in applications that benefit from the high power and brightness of the embodied laser source produced using the coherent beam combining system. These applications may include, for example, materials processing, such as welding, drilling, cutting, annealing and brazing; marking; laser pumping; medical applications; and directed energy applications. In many of these applications, the laser source formed by the coherent beam combining system may be incorporated into a machine tool and/or robot to facilitate performance of the laser application.

While the invention herein disclosed has been described by means of specific embodiments and applications thereof, numerous modifications and variations could be made thereto by those skilled in the art without departing from the scope of the invention set forth in the claims.

I claim:

1. A coherent laser beam combiner comprising:
a set of three or less laser beams (101) (102) (103), wherein each laser beam (101) (102) (103) has optical radiation having the same wavelength and is directed toward a beam overlap region (108) at specified angles (105) (106); and
a repeated pattern optical element (111) having at least two repeated patterns (18), having a repeated pattern period (19), having diffraction efficiency in at least two diffraction orders, having diffraction efficiency in at least two angles, placed near the overlap region (108), configured to receive the three or less laser beams (101) (102) (103), and positioned in two-directions of translation (114) to phase the three or less laser beams (101) (102) (103) improving coherent combining efficiency.

2. The coherent laser beam combiner as claimed in claim 1, wherein the repeated pattern optical element (111) is a diffractive optical element.

3. The coherent laser beam combiner as claimed in claim 1, wherein the repeated pattern optical element (111) is a Dammann Grating.

4. The coherent laser beam combiner as claimed in claim 1, wherein the repeated pattern optical element (111) is a volume Bragg grating.

5. The coherent laser beam combiner as claimed in claim 1, wherein the repeated pattern optical element (111) is a holograph optical element.

6. The coherent laser comprising:
a set of three or less laser beam paths (205);
a set of three or less laser gain medium (201) (202) (203), each one positioned in one of the three or less laser beam paths (205);
a set of three or less high reflector surfaces (207) at one end of each three or less laser paths (205);
a set of three or less beam shaping and directing optical elements (206) positioned in one of the three or less laser beam paths (205) and directing the each one of three laser beam paths (205) toward an overlap region (208);
a repeated pattern optical element (210) having at least two repeated patterns (18), having a repeated pattern period (19), having diffraction efficiency in at least two diffraction orders, having diffraction efficiency in at least two angles, placed near the overlap region (208), and positioned in two-directions of translation (218) to phase the three or less laser beam paths (205) for improved coherent combining efficiency,
an combined beam optical beam path (212);
a beam shaping and directing optical element (209) positioned in the combined beam optical beam path (212); and
a partially reflecting output coupler (211) positioned in the combined beam optical beam path (212) to complete the external laser resonator beam paths (205) (212) with the high reflectively surfaces (207) thereby allowing laser action to occur along the beam paths (205) (212) with improved efficiency through the repeated pattern optical element (210) and creating a set of three or less laser beams (205) and a combined beam (214) and a combined beam output (215).
